(19) United States
(12) Patent Application Publication
(10) Pub. No.: US 2018/0167279 A1
(43) Pub. Date: Jun. 14, 2018

(54) POLICY BASED ROUTING RESPECTING NETWORK CONDITIONS

(71) Applicant: Alcatel-Lucent, Nozay (FR)

(72) Inventors: Zhi WANG, Shanghai (CN); Yigang CAI, Naperville, IL (US)

(73) Assignee: Alcatel Lucent, Nozay (FR)

(21) Appl. No.: 15/580,869

(22) PCT Filed: Jun. 1, 2016
(86) PCT No.: PCT/IB2016/000921

§ 371 Date: Dec. 8, 2017

(30) Foreign Application Priority Data
Jun. 12, 2015 (CN) 201510324233.1

(51) Int. Cl. H04L 12/24; H04L 29/08; H04L 12/725

(52) U.S. Cl. CPC H04L 41/0893; H04L 45/306; H04L 67/322; H04L 67/12

(57) ABSTRACT

An object of the invention is providing methods, apparatuses, and system for steering operations corresponding to a trigger request. A steering device obtains one or more steering policy parameters transmitted by an application server, and then, based on one or more network conditions and a predetermined operation corresponding to the network condition included in the steering policy parameter, detects a current network situation; if the current network situation matches the network condition, executes the predetermined operation corresponding to the network condition to the trigger request transmitted by the application server based on the steering policy parameter. Compared with the prior art, the present invention realizes that an operation to a trigger request can be steered by a steering device, and has the advantages such as steering the response to the trigger request, enhancing the efficiency of application, enhancing network reliability and functionality, and higher rate of innovation, etc.

### FIELD OF THE INVENTION

The present invention relates to the field of telecommunication, and in particular to the technology of steering operations corresponding to a trigger request.

### BACKGROUND OF THE INVENTION

3GPP TS 23.682 provides the 3GPP Architecture for Machine-Type Communications which enables the Application Servers access the data/service of IoT devices base on the demand of specific applications. However, as a network consisted of a wide variety of resource constrained devices such as temperature sensors, metering devices, biochip transponders on farm animals, automobiles with built-in sensors, or field operation devices that assist fire-fighters in search and rescue, etc. . . . one key characteristic of Internet of Things (IoT) is the un-stability of IoT devices. IoT devices may be unavailable for any reasons like loss of connectivity, communication failure, computing resource shortage, powered off, sleep, overloaded, security reasons, etc. . . .

Therefore, to provide necessary data/service steadily for the high level applications, one critical issue of IoT is how to route device trigger request efficiently to appropriate destination while the network condition of IoT is changing frequently.

Some existing technologies like message forwarding and message delivery report provide preliminary solutions for this problem. In these solutions, if the destination IoT device is unavailable, the device trigger request can be forwarded to an alternative device pre-defined or a delivery failure report will be returned to the Application Server to trigger error handling on it. However, all these solutions are not good enough:

1. The message forwarding solution does not consider the requirements of the application which triggers the device trigger request. Without the input from application, the alternative device may not be a good choice.

2. Delivery report is not a good solution too. Because the report may be delayed because of message delivery delay (e.g. caused by UE unreachable, out of memory, etc. . . . ), it cannot support the low latency scenarios. Moreover, the existing delivery report mechanism is very limited and only works for some fixed scenarios, which cannot track all needed steps of message delivery along its path. With existing delivery report mechanism, Application Server cannot take timely actions to respond the frequent network condition change of IoT.

Besides, based on working on MTC Monitoring Enhancements, 3GPP provides another solution for this problem by enabling monitoring of related events. However, enabling monitoring for each device trigger request is obviously an inefficient and low cost solution.

### SUMMARY OF THE INVENTION

An object of the invention is providing methods, apparatuses, and system for steering operations corresponding to a trigger request.

According to one aspect of the invention, a method for steering operations corresponding to a trigger request in a steering device is provided, wherein the method comprises:

x. obtaining one or more steering policy parameters transmitted by an application server, wherein the steering policy parameter includes one or more network conditions and a predetermined operation corresponding to the network condition;

wherein the method further comprises:

a. detecting whether a current network situation matches the network condition;

b. if the current network situation matches the network condition, executing the predetermined operation corresponding to the network condition to the trigger request transmitted by the application server based on the steering policy parameter.

According to another aspect of the invention, a method for facilitating steering of operations corresponding to a trigger request in an application server is further provided, wherein the method comprises:

X. transmitting one or more trigger requests and steering policy parameters to a steering device, wherein the steering policy parameter includes one or more network conditions and a predetermined operation corresponding to the network condition.

According to another aspect of the invention, a steering device for steering operations corresponding to a trigger request is further provided, wherein, the device comprises:

a policy obtaining module configured to obtain one or more steering policy parameters transmitted by an application server, wherein the steering policy parameter includes one or more network conditions and a predetermined operation corresponding to the network condition;

wherein the device further comprises:

a detecting module configured to detect whether a current network situation matches the network condition;

an executing module configured to, if the current network situation matches the network condition, execute the predetermined operation corresponding to the network condition to the trigger request transmitted by the application server based on the steering policy parameter.

According to another aspect of the invention, an application server for facilitating steering of operations corresponding to a trigger request is further provided, wherein the application server comprises:

a policy transmitting module configured to transmit one or more trigger requests and steering policy parameters to a steering device, wherein the steering policy parameter includes one or more network conditions and a predetermined operation corresponding to the network condition.

According to another aspect of the invention, a system for steering operations corresponding to a trigger request is further provided, wherein the system comprises the steering device as foresaid, and the application server as foresaid.

Compared with the prior art, the present invention obtains, by a steering device, one or more steering policy parameters transmitted by an application server, and then, based on one or more network conditions and a predetermined operation corresponding to the network condition included in the steering policy parameter, detects a current network situation; if the current network situation matches the network condition, executes the predetermined operation corresponding to the network condition to the trigger request transmitted by the application server based on the steering policy parameter. Therefore, the present invention realizes that an operation to a trigger request can be steered by a steering device, and has the following advantages:
Steering the response to the trigger request: Since the steering policy parameters are determined by the application service, the application software can fully control the handling of its device trigger, which guarantees the result of operations of the trigger request can reflect the demand of application as more as possible.
Enhancing the efficiency of application: The present invention handles various kinds of network details by the steering device, which makes the application server may ignore more network details; the present invention could handle the trigger request by the application upper layer, enables application focus on application specific logic without distraction by the frequent change in network.
Enhancing network reliability and functionality: Since the steering device could concentrate to detect the current network situation, the steering device could concentrate to take care of all the frequent change of conditions, and take fully advantage of the knowledge of network, timely respond to network conditions change.
Higher rate of innovation: The present invention enables communications programmable. It enables application to tailor the behavior of the network and introduce new service and network capability quickly.

Moreover, the present invention could be used in IoT network, which enables programmable IoT communications and timely responds to network conditions change in IoT. The present invention enables application focus on application specific logic without distraction by the frequent change in IoT network. The present invention can apply to any IoT architecture/applications.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1 shows a schematic diagram of a service exposure framework with a policy of steering operations corresponding to a trigger request according to one preferred embodiment of the present invention;

FIG. 2 shows a schematic diagram of a steering device and an application server for steering operations corresponding to a trigger request according to one aspect of the present invention;

FIG. 3 shows a flow diagram of a method for steering operations corresponding to a trigger request by cooperation of a steering device and an application server according to another aspect of the present invention;

FIG. 4 shows a flow diagram of a method for alternative destination of a trigger request in an IoT network according to one preferred embodiment of the present invention;

FIG. 5 shows a flow diagram of a method for adding delivery conditions for a trigger request in an IoT network according to another preferred embodiment of the present invention.

The same or similar reference signs in the drawings represent the same or similar component parts.

### DETAILED DESCRIPTION OF THE INVENTION

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. The processes may correspond to methods, functions, procedures, subroutines, subprograms, etc.

The “steering device” or “application server” herein comprises any computer device that can perform information processing. Here, the “computer device” (or called “computer”) refers to an intelligent electronic device that performs predetermined processing processes such as numerical value calculations and/or logical calculations by running predetermined programs or instructions, which may comprise a processor and a memory. The predetermined processing process is executed by the processor through executing program instructions pre-stored in a memory, or the predetermined processing process is executed by hardware such as ASIC, FPGA, DSP, etc., or the predetermined processing process is executed by a combination of both.

The computer device includes, but not limited to, network device or a device integrated by network device(s) and user device(s) through a network. The network device includes, but not limited to, personal computer(s), network host(s), single network server, a set of multiple network servers or a cloud network formed by multiple servers; herein, the cloud network is formed by a large number of computers or network servers based on Cloud Computing, wherein, the cloud computing is a kind of distributed computing, which is a virtual supercomputer consisting of a group of loosely coupled computers set. Wherein, the computer device may run separately to implement the present invention, or implement the present invention through interaction operations with other computer devices in the network by accessing the network. The network of the computer device includes, but not limited to, the Internet, the Internet of Things, Wide Area Network, Metropolitan Area Network, LAN, VPN, wireless self-organizing network (Ad Hoc network), etc.

Besides, the user device includes, but not limited to, any electronic product could process man-machine interactions with the user through keyboard, remote-control unit, touch panel, or acoustic equipment, such as personal computers, smart phones, PDAs, game consoles, or IPTV and so on. Besides, the user equipment further comprises a device that needn't interact with the user to implement information collection and transmission, e.g., a sensor, etc.

It should be noted that the user device, network device, and network are only examples, and other existing or future possibly emerging computer device or network, if applicable to the present invention, should also be included within the protection scope of the present invention and is incorporated here by reference.

Specific structural and functional details disclosed herein are merely representative for purposes of describing example embodiments of the present invention. This invention may, however, be embodied in many alternate forms and should not be construed as limited to only the embodiments set forth herein.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Below, details of the invention will be further provided in combination with the accompanying drawings.

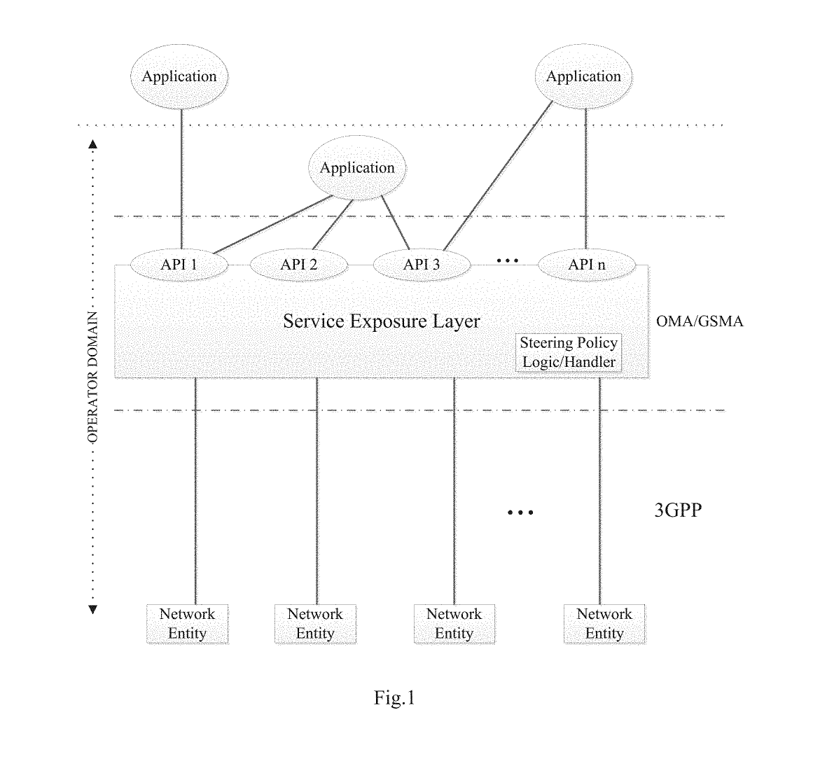

FIG. 1 shows a schematic diagram of a service exposure framework with a policy of steering operations corresponding to a trigger request according to one preferred embodiment of the present invention.

In FIG. 1, the “Steering Policy Logic/Handler” in the present invention is introduced or deployed on a Service Exposure Layer in operator's major network. Here, the “Steering Policy Logic” corresponds to the “method for steering operations corresponding to a trigger request in a steering device” in the context, and the “Steering Policy Handler” corresponds to the “steering device for steering operations corresponding to a trigger request”.

Various kinds of applications transmit the steering policies set by the applications to the service exposure layer through one or more APIs negotiated with the service exposure layer, so as to collectively steering by the service exposure layer. The service exposure layer detects the network conditions based on the one or more steering policies; if the criteria are met, corresponding operations are performed to the trigger request of the application.

At the ease of illustration, FIG. 1 takes a 3GPP architecture as an example. Those skilled in the art should understand, the service exposure framework with a policy of steering operations corresponding to a trigger request is similar to FIG. 1, which will not be detailed here and is likewise included within the protection scope of the present invention.

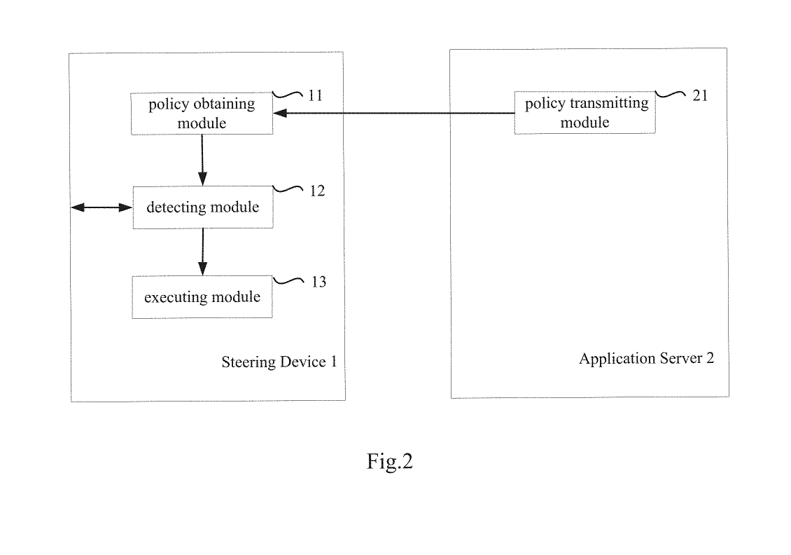

FIG. 2 shows a schematic diagram of a steering device and an application server for steering operations corresponding to a trigger request according to one aspect of the present invention; wherein the steering device 1 comprises a policy obtaining module 11, a detecting module 12, an executing module 13, the application server 2 comprises a policy transmitting module 21. Specifically, the policy transmitting module 21 of the application server 2 transmits one or more trigger requests and steering policy parameters to a steering device, wherein the steering policy parameter includes one or more network conditions and a predetermined operation corresponding to the network condition; correspondingly, the policy obtaining module 11 of the steering device 1 obtains one or more steering policy parameters transmitted by the application server; then the detecting module 12 of the steering device 1 detects whether a current network situation matches the network condition; if the current network situation matches the network condition, the executing module 13 executes the predetermined operation corresponding to the network condition to the trigger request transmitted by the application server based on the steering policy parameter.

The policy transmitting module 21 of the application server 2 transmits one or more trigger requests and steering policy parameters to a steering device, wherein the steering policy parameter includes one or more network conditions and a predetermined operation corresponding to the network condition.

Specifically, the policy transmitting module 21 transmits, simultaneously or non-simultaneously one or more trigger requests and steering policy parameters to the steering device through corresponding communication protocols based on preset APIs. For example, the policy transmitting module 21 first transmits the one or more steering policy parameters to the steering device, the steering policy parameters being stored by the steering device. The steering policy parameters may correspond to a plurality of trigger requests. Then, when the application server 2 needs to perform a trigger request, it transmits the trigger request to the steering device. Or, the policy steering module 21 transmits the one or more trigger requests and the steering policy parameters simultaneously to the steering device. Here, the steering policy parameters may only correspond to the transmitted trigger request, or may also contain other steering policy parameters corresponding to the trigger requests that have not been transmitted yet, which are available for use after storage by the steering device.

Here, the network conditions and predetermined operations in the steering policy parameters may directly write the specific indication contents into the steering policy parameters or may be indicated based on the predefined digital IDs. When the digital IDs are adopted for indication, the specific network conditions and predetermined operations corresponding to these digital IDs may be pre-configured in the application server and the steering device; therefore, when steering policy parameters are transmitted between the application server and the steering device, it is only required to identify the digital ID in corresponding messages.

Here, the network conditions include, but not limited to, multiple dimensions depending on network measurements and thresholds. Any detection supported by any network entity in the network can be included as the network conditions. For example, the network conditions include, but not limited to, network entity (e.g., UE)'s location, time, unsuccessful delivery attempt(s), the message is queued in waiting list, message delivery delay, charging rate for the delivery, temporarily absence of the destination device, etc. . . .

Here, the predetermined operations include, but not limited to, at least any one of the following:
Alternative Destination. It indicates the message should be forwarded to alternative device indicated by this operation if conditions are met.
Conditional Delivery. Deliver the message to be delivered (e.g., M2M message) until the conditions are met. For example, deliver until the target device complies a specific state (e.g., at a specific address, being idle, etc.), deliver at specific time, or if charging rate for the delivery being variable, deliver when the charging rate is the lowest.
Drop. Discarded the message to be delivered (e.g., M2M message) if conditions are met.
Report. Report this situation to the message originator (e.g. AS, SCS, other 3rd party server, IoT devices, etc. . . . ).
Report for further instruction. Report to the message originator and hold the message until the instruction from the originator is received. Example of the instruction from the originator may be message recall or replace.
Alternative payload. Replace current payload with new payload if conditions are met. Here, the new payload may be backup payload carried in the message or a payload preset at the application server.
Alternative Trigger/Message Parameters like Priority. Validity, etc. . . .
Etc. . . .

Here, those skilled in the art should understand that the above network conditions and predetermined operations may be one to one, one to more, or more to more. Further, the steering policy parameters may also comprise multiple mappings between network conditions and predetermined operations. For example, when a certain network condition is met, predetermined operation A is executed; if execution of the predetermined operation A fails, predetermined operation B continues to be executed.

Correspondingly, the policy obtaining module 11 of the steering device 1 obtains one or more steering policy parameters transmitted by the application server.

Specifically, the policy obtaining module 11 obtains the steering policy parameters from the application server through corresponding protocols based on preset APIs. Further, the policy obtaining module 11 stores the steering policy parameters.

Here, when the steering policy parameters are stored, the steering policy parameters may be associated with the application server, i.e., the steering policy parameters transmitted by the application server are only applied when obtaining the trigger request transmitted by the same application server; the steering policy parameters may not be associated with the application server, i.e., the above steering policy parameters are applied whenever a trigger request transmitted from any application server is obtained. The steering policy parameters may also be associated with a specific application server, e.g., after steering policy parameters transmitted by one application server is obtained, the steering policy parameters may also be applied to a trigger request from other application server that belongs to the same network segment with the application server. Here, those skilled in the art should understand that other conditions applied for limiting the above specific application servers are likewise applicable to the present invention and included within the protection scope of the present invention.

Here, the policy obtaining module 11 may directly obtain the steering policy parameters voluntarily transmitted by the application server; or may send a parameter obtaining request to the application server, such that the application server transmits the steering policy parameters to the steering device based on the parameter obtaining request; may also extract the steering policy parameters from the trigger request based on the trigger request of the application server.

Preferably, the policy transmitting module 21 may transmit one or more trigger requests to the steering device, wherein the trigger request includes one or more steering policy parameters, and the steering policy parameter includes one or more network conditions and a predetermined operation corresponding to the network condition. Correspondingly, the policy obtaining module 11 may obtain one or more trigger requests transmitted by the application server, wherein the trigger request includes one or more steering policy parameters, and then obtains the steering policy parameters based on the trigger request.

Specifically, the policy transmitting module 21 introduces the steering policy parameters in the transmitted trigger request, and then transmits the trigger request to the steering device through corresponding communication protocols based on the preset APIs; the steering device, after obtaining the trigger request, extracts the steering policy parameters from the trigger request, such that when the network condition satisfies the conditions in the steering policy parameters, a predetermined operation in the steering policy parameters is executed to the trigger request.

Here, those skilled in the art should understand, when the trigger request includes one or more steering policy parameters, the steering policy parameters are just the steering policy parameters applied by the trigger request; besides, if other agreements exist, the steering policy parameters may be applied to other trigger requests.

Preferably, the application service further comprises a policy generating module (not shown), wherein, the policy generating module generates one or more steering policy parameters based on application demand information, wherein the steering policy parameter includes one or more network conditions and a predetermined operation corresponding to the network condition; the policy transmitting module 21 transmits one or more trigger requests and the steering policy parameters to the steering device.

Specifically, the policy generating module generates, based on the application demand information of the application corresponding to the application server, steering policy parameters in agreement with the application demand information, wherein the application demand information includes, but not limited to, server provider's information, timeline demand, location demand, priority demand, and service payment demand, etc. Here, because the application server autonomously generates the steering policy parameters, the generated steering policy parameters can well satisfy the demand of the application server in various kinds of situations.

Those skilled in the art should understand that besides autonomous generation by the policy generating module, the application server may also obtain the steering policy parameters from other third-party devices or directly employ the default steering policy parameters, etc.

Then, the policy transmitting module 21 transmits the generated steering policy parameters and trigger requests to the steering device through corresponding communication protocols based on the preset APIs.

Here, the method for the policy transmitting module 21 to transmit the trigger requests and the steering policy parameters is identical or similar to that for the policy transmitting module 21 as shown in FIG. 2, which will not be detailed here and is incorporated here by reference.

Then the detecting module 12 of the steering device 1 detects whether a current network situation matches the network condition; if the current network situation matches the network condition, the executing module 13 executes the predetermined operation corresponding to the network condition to the trigger request transmitted by the application server based on the steering policy parameter.

Specifically, the detecting module 12 first obtains the current network situation. Here, obtaining of the network situation may be obtained by the steering device through direct monitoring, or obtained from other devices in the network, e.g., based on any monitoring supported by any network entity (e.g., delivery node) in the network, obtained from the network entity through relevant messages.

Then, the detecting module 12 continuously matches the current network situation and the network condition; if the current network situation and the network condition do not match, then a process of last monitoring and matching will be repeated; if the current network situation and the network condition match, then the executing module 13 executes the predetermined operation corresponding to the network condition to the trigger request based on the steering policy parameter.

Preferably, if the current network situation matches the network condition, based on the steering policy parameter and in conjunction with payload information in the trigger request transmitted by the application server, the executing module 13 may execute the predetermined operation corresponding to the network condition and the payload information to the trigger request.

Specifically, based on the steering policy parameters, the executing module 13 may also perform a comprehensive analysis of the network condition and the payload information based on the payload information in the trigger request, so as to determine a predetermined operation. For example, the payload information may contain specific content to be executed, or contents of operation steering with a higher or lower priority than the steering policy parameters.

For example, if the steering policy parameter is “when the initial destination address is inaccessible, change the destination address,” while the payload information contains “destination address to be changed”; then the executing module 13, taking the two into account comprehensively, uses the destination address in the payload information as the substitution address when the initial destination address is inaccessible, and forwards the trigger request to the destination address in the payload information.

Here, in general circumstances, the priority of the steering policy parameter is the highest, but it may also be adjusted in real-time based on the payload information. For example, if the payload information contains contents of operation steering with the highest steering priority, the operation in the payload information will be adopted in priority.

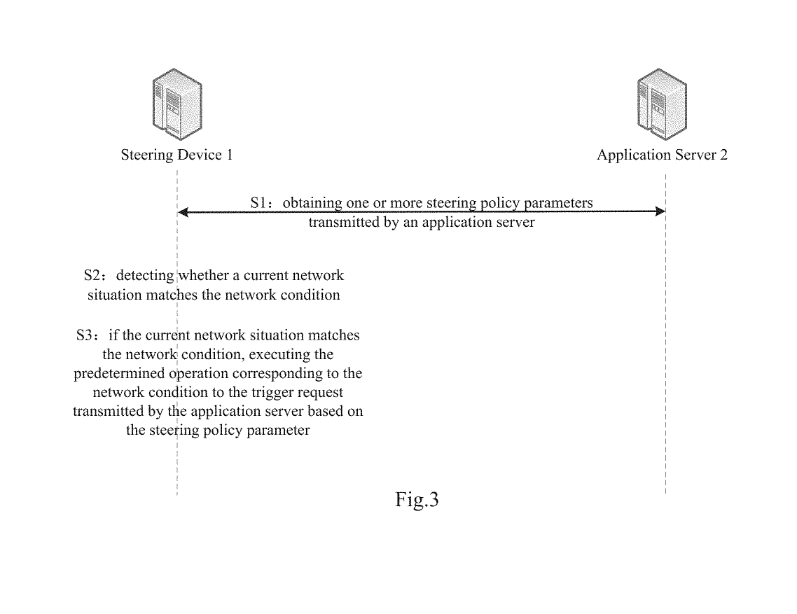

FIG. 3 shows a flow diagram of a method for steering operations corresponding to a trigger request by cooperation of a steering device and an application server according to another aspect of the present invention. Specifically, in the step S1, the application server 2 transmits one or more trigger requests and steering policy parameters to a steering device, wherein the steering policy parameter includes one or more network conditions and a predetermined operation corresponding to the network condition; correspondingly, in the step S1, the steering device 1 obtains one or more steering policy parameters transmitted by the application server; then in the step S2, the steering device 1 detects whether a current network situation matches the network condition; if the current network situation matches the network condition, in the step S3, the steering device 1 executes the predetermined operation corresponding to the network condition to the trigger request transmitted by the application server based on the steering policy parameter.

In the step S1, the application server 2 transmits one or more trigger requests and steering policy parameters to a steering device, wherein the steering policy parameter includes one or more network conditions and a predetermined operation corresponding to the network condition.

Specifically, in the step S1, the application server 2 transmits, simultaneously or non-simultaneously one or more trigger requests and steering policy parameters to the steering device through corresponding communication protocols based on preset APIs. For example, in the step S1, the application server 2 first transmits the one or more steering policy parameters to the steering device, the steering policy parameters being stored by the steering device. The steering policy parameters may correspond to a plurality of trigger requests. Then, when the application server 2 needs to perform a trigger request, it transmits the trigger request to the steering device. Or, in the step S1, the application server 2 transmits the one or more trigger requests and the steering policy parameters simultaneously to the steering device. Here, the steering policy parameters may only correspond to the transmitted trigger request, or may also contain other steering policy parameters corresponding to the trigger requests that have not been transmitted yet, which are available for use after storage by the steering device.

Here, the network conditions and predetermined operations in the steering policy parameters may directly write the specific indication contents into the steering policy parameters or may be indicated based on the predefined digital IDs. When the digital IDs are adopted for indication, the specific network conditions and predetermined operations corresponding to these digital IDs may be pre-configured in the application server and the steering device; therefore, when steering policy parameters are transmitted between the application server and the steering device, it is only required to identify the digital ID in corresponding messages.

Here, the network conditions include, but not limited to, multiple dimensions depending on network measurements and thresholds. Any detection supported by any network entity in the network can be included as the network conditions. For example, the network conditions include, but not limited to, network entity (e.g., UE)'s location, time, unsuccessful delivery attempt(s), the message is queued in waiting list, message delivery delay, charging rate for the delivery, temporarily absence of the destination device, etc. . . .

Here, the predetermined operations include, but not limited to, at least any one of the following:
Alternative Destination. It indicates the message should be forwarded to alternative device indicated by this operation if conditions are met.
Conditional Delivery. Deliver the message to be delivered (e.g., M2M message) until the conditions are met. For example, deliver until the target device complies a specific state (e.g., at a specific address, being idle, etc.), deliver at specific time, or if charging rate for the delivery being variable, deliver when the charging rate is the lowest.
Drop. Discarded the message to be delivered (e.g., M2M message) if conditions are met.
Report. Report this situation to the message originator (e.g. AS, SCS, other 3rd party server, IoT devices, etc. . . . ).
Report for further instruction. Report to the message originator and hold the message until the instruction from the originator is received. Example of the instruction from the originator may be message recall or replace.
Alternative payload. Replace current payload with new payload if conditions are met. Here, the new payload may be backup payload carried in the message or a payload preset at the application server.
Alternative Trigger/Message Parameters like Priority. Validity, etc. . . .
Etc. . . .

Here, those skilled in the art should understand that the above network conditions and predetermined operations may be one to one, one to more, or more to more. Further, the steering policy parameters may also comprise multiple mappings between network conditions and predetermined operations. For example, when a certain network condition is met, predetermined operation A is executed; if execution of the predetermined operation A fails, predetermined operation B continues to be executed.

Correspondingly, in the step S1, the steering device 1 obtains one or more steering policy parameters transmitted by the application server.

Specifically, in the step S1, the steering device 1 obtains the steering policy parameters from the application server through corresponding protocols based on preset APIs. Further, in the step S1, the steering device 1 stores the steering policy parameters.

Here, when the steering policy parameters are stored, the steering policy parameters may be associated with the application server, i.e., the steering policy parameters transmitted by the application server are only applied when obtaining the trigger request transmitted by the same application server; the steering policy parameters may not be associated with the application server, i.e., the above steering policy parameters are applied whenever a trigger request transmitted from any application server is obtained. The steering policy parameters may also be associated with a specific application server, e.g., after steering policy parameters transmitted by one application server is obtained, the steering policy parameters may also be applied to a trigger request from other application server that belongs to the same network segment with the application server. Here, those skilled in the art should understand that other conditions applied for limiting the above specific application servers are likewise applicable to the present invention and included within the protection scope of the present invention.

Here, in the step S1, the steering device 1 may directly obtain the steering policy parameters voluntarily transmitted by the application server; or may send a parameter obtaining request to the application server, such that the application server transmits the steering policy parameters to the steering device based on the parameter obtaining request; may also extract the steering policy parameters from the trigger request based on the trigger request of the application server.

Preferably, in the step S1. the application server 2 may transmit one or more trigger requests to the steering device, wherein the trigger request includes one or more steering policy parameters, and the steering policy parameter includes one or more network conditions and a predetermined operation corresponding to the network condition. Correspondingly, in the step S1, the steering device may obtain one or more trigger requests transmitted by the application server, wherein the trigger request includes one or more steering policy parameters, and then obtains the steering policy parameters based on the trigger request.

Specifically, in the step S1, the application server 2 introduces the steering policy parameters in the transmitted trigger request, and then transmits the trigger request to the steering device through corresponding communication protocols based on the preset APIs; the steering device, after obtaining the trigger request, extracts the steering policy parameters from the trigger request, such that when the network condition satisfies the conditions in the steering policy parameters, a predetermined operation in the steering policy parameters is executed to the trigger request.

Here, those skilled in the art should understand, when the trigger request includes one or more steering policy parameters, the steering policy parameters are just the steering policy parameters applied by the trigger request; besides, if other agreements exist, the steering policy parameters may be applied to other trigger requests.

Preferably, the method further comprises a step S4 (not shown), wherein, in the step S4, the application server 2 generates one or more steering policy parameters based on application demand information, wherein the steering policy parameter includes one or more network conditions and a predetermined operation corresponding to the network condition; in the step S1, the application server 2 transmits one or more trigger requests and the steering policy parameters to the steering device.

Specifically, in the step S4, the application server 2 generates, based on the application demand information of the application corresponding to the application server, steering policy parameters in agreement with the application demand information, wherein the application demand information includes, but not limited to, server provider's information, timeline demand, location demand, priority demand, and service payment demand, etc. Here, because the application server autonomously generates the steering policy parameters, the generated steering policy parameters can well satisfy the demand of the application server in various kinds of situations.

Those skilled in the art should understand that besides autonomous generation by the policy generating module, the application server may also obtain the steering policy parameters from other third-party devices or directly employ the default steering policy parameters, etc.

Then, in the step S1, the application server 2 transmits the generated steering policy parameters and trigger requests to the steering device through corresponding communication protocols based on the preset APIs.

Here, the method of the application server 2 to transmit the trigger requests and the steering policy parameters is identical or similar to that of the step S1 as shown in FIG. 3, which will not be detailed here and is incorporated here by reference.

Then in the step S2, the steering device 1 detects whether a current network situation matches the network condition; if the current network situation matches the network condition, in the step S3, the steering device 1 executes the predetermined operation corresponding to the network condition to the trigger request transmitted by the application server based on the steering policy parameter.

Specifically, in the step S2, the steering device 1 first obtains the current network situation. Here, obtaining of the network situation may be obtained by the steering device through direct monitoring, or obtained from other devices in the network, e.g., based on any monitoring supported by any network entity (e.g., delivery node) in the network, obtained from the network entity through relevant messages.

Then, in the step S2, the steering device 1 continuously matches the current network situation and the network condition; if the current network situation and the network condition do not match, then a process of last monitoring and matching will be repeated; if the current network situation and the network condition match, then in the step S3, the steering device 1 executes the predetermined operation corresponding to the network condition to the trigger request based on the steering policy parameter.

Preferably, if the current network situation matches the network condition, based on the steering policy parameter and in conjunction with payload information in the trigger request transmitted by the application server, in the step S3, the steering device 1 may execute the predetermined operation corresponding to the network condition and the payload information to the trigger request.

Specifically, based on the steering policy parameters, in the step S3, the steering device 1 may also perform a comprehensive analysis of the network condition and the payload information based on the payload information in the trigger request, so as to determine a predetermined operation. For example, the payload information may contain specific content to be executed, or contents of operation steering with a higher or lower priority than the steering policy parameters.

For example, if the steering policy parameter is “when the initial destination address is inaccessible, change the destination address,” while the payload information contains “destination address to be changed”; then the steering device, taking the two into account comprehensively, uses the destination address in the payload information as the substitution address when the initial destination address is inaccessible, and forwards the trigger request to the destination address in the payload information.

Here, in general circumstances, the priority of the steering policy parameter is the highest, but it may also be adjusted in real-time based on the payload information. For example, if the payload information contains contents of operation steering with the highest steering priority, the operation in the payload information will be adopted in priority.

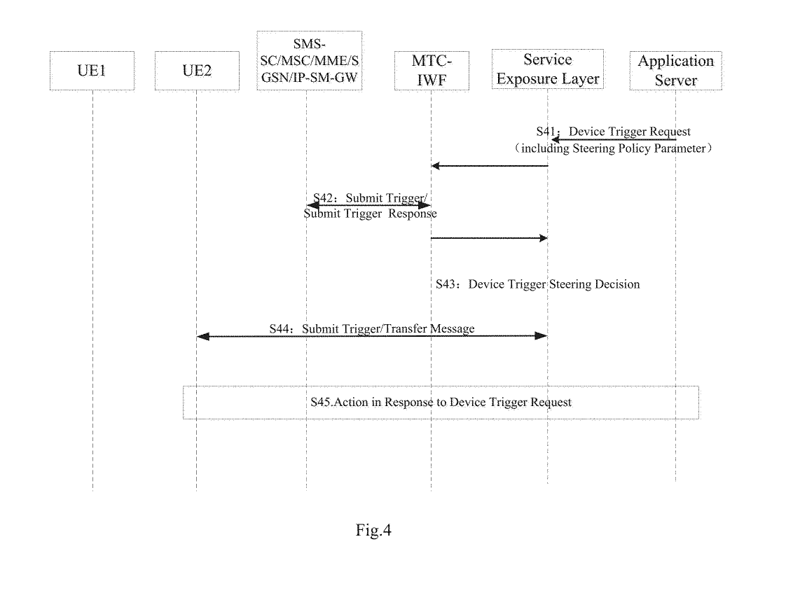

FIG. 4 shows a flow diagram of a method for alternative destination of a trigger request in an IoT network according to one preferred embodiment of the present invention.

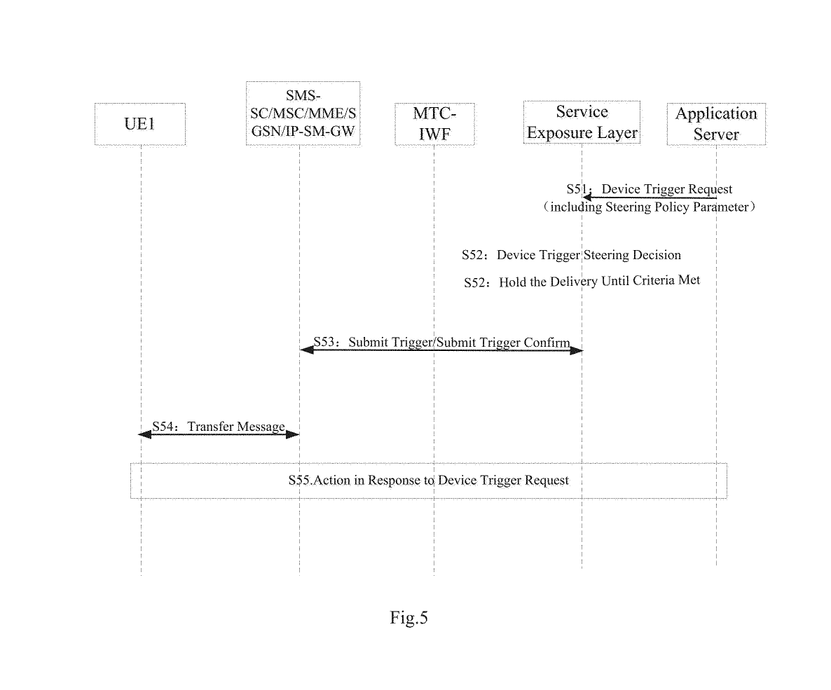

Here, those skilled in the art should understand, at the ease of description, FIGS. 4 and 5 will use the IoT network as an example. The service exposure layer is deployed a steering device so as to obtain the steering policy parameters and steer the trigger request. The trigger request transmitted by the application server is a device trigger request. Actually, besides IoT, the present invention is also applicable to other application. For example, other applications supported by the service exposure layer in the major network of the operator.

In the scenario of the FIG. 4, the origination destination for this device trigger request transmitted by the application server is UE 1. New steering policy parameter is added into device trigger request with below criteria and action map:

Criteria: Origination destination (i.e. UE1) is unreachable

Action: Alternative Destination is UE2

Step S41: Application server generates the steering policy parameter base on the demand of specific application and inserts it into the device trigger request. The device trigger request is sent to MTC-IWF through the enhanced service exposure layer. The “steering policy logic/handler” in service exposure layer saves the steering policy parameter received from AS for further handling if needed. The “steering policy logic/handler” would further retrieve the network situation in the conditions of steering policy parameter and monitor the change of these network situations for the further handling of steering policy.

Step S42: The MTC-IWF selects a suitable SMS-SC based on configured information. The MTC-IWF sends a submit trigger to the selected SMS-SC and receives the submit trigger confirm/response from the SMS-SC.

Step S43: In this example, the origination destination (i.e. UE1) is unreachable and this is reported to enhanced service exposure layer (Note: this can also be monitored by enhanced service exposure layer depend on the implementation). Then, below logic will apply:

1. Retrieve the steering policy parameter from device trigger request. If there is, go to the next step.

2. Retrieve the criteria from the steering policy parameter, keep checking if the criteria are matched or not. If the criteria are met, corresponding action(s) applies.

In this example, because the origination destination (i.e. UE1) is unreachable, the steering policy handler in the service exposure layer will perform the corresponding action, that is, replace the destination address with the one indicated by alternative destination and then, deliver the message as normal.

Step S44: The short message is delivered to the UE2.

Step S45: In response to the received device trigger, the UE takes specific actions. This response typically involves initiation of immediate or later communication with the SCS or an AS. When the steering policy parameter comprises processing with respect to a response, the steering policy handler will check the network condition for the response, and performs an appropriate operation to the response information when the condition is met.

Here: If UE1 is unavailable, even if a pre-defined alternative device is included in the original trigger request, the alternative device may be overwritten by the steering policy parameter based on the pre-set configured information.

FIG. 5 shows a flow diagram of a method for adding delivery conditions for a trigger request in an IoT network according to another preferred embodiment of the present invention.

In the scenario of the FIG. 5, Application Server wants to access the data of a moving MTC device within a certain region. Then, the steering policy parameter is added into device trigger request with below criteria and action map:

Criteria: Position=39.9200,21.1000-37.2400,20.1500″ (It means if the MTC UE's position is in the area defined by given location range.)

Action: Conditional Delivery

Step S51: Similar to the step S41, but the steering policy parameter included in step S51 is different from the steering policy parameter in the step S41.

S52: The “steering policy handler” on service exposure layer checks if the UE's position is met the conditional delivery criteria, if it does not match, hold the message until the criteria are met.

Step S53: The service exposure layer submits a trigger to a relevant device (e.g., SMS-SC) based on the configured information, and receives a submit trigger confirmation/response from the device.

Step S54: The short message is delivered to UE1 via a relevant device such as SMS-SC.

Step S55: UE executes corresponding actions in response to the received device trigger. When the steering policy parameter comprises processing with respect to a response, the steering policy handler will check the network condition for the response, and performs an appropriate operation to the response information when the condition is met.

It should be noted that the present invention may be implemented in software and/or a combination of software and hardware, for example, it may be implemented by an application-specific integrated circuit (ASIC), a general purpose computer or any other similar hardware device. In one embodiment, the software program of the present invention may be executed through a processor to implement the steps or functions as mentioned above. Likewise, the software program of the present invention (including relevant data structure) may be stored in the computer-readable recording medium, for example, RAM memory, magnetic or optic driver or flappy disk or similar devices. Besides, some steps or functions of the present invention may be implemented by hardware, for example, as a circuit cooperating with the processor to execute various steps or functions.

Besides, a part of the present invention may be applied as a computer program product, e.g., computer program instructions, which, when being executed by the computer, may invoke or provide the method and/or technical solution according to the present invention through operations of the computer, while the program instructions for invoking the method of the present invention may be stored in a fixed or mobile recording medium, and/or transmitted through broadcast or a data stream in other signal carrier medium, and/or stored in a work memory of a computer device running based on the program instructions. Here, one embodiment according to the present invention comprises an apparatus, which comprising a memory for storing the computer program instructions and a processor for executing the program instructions, wherein when the computer program instructions are executed by the processor, the apparatus is triggered to run the above mentioned methods and/or technical solutions according to multiple embodiments of the present invention.

To those skilled in the art, it is apparent that the present invention is not limited to the details of above exemplary embodiments, and the present invention can be implemented with other specific embodiments without departing the spirit or basic features of the present invention. Thus, from any perspective, the embodiments should be regarded as illustrative and non-limiting. The scope of the present invention is limited by the appended claims, instead of the above description. Thus, meanings of equivalent elements falling within the claims and all variations within the scope are intended to be included within the present invention. Any reference numerals in the claims should not be regarded as limiting the involved claims. Besides, it is apparent that such terms as “comprise” and “include” do not exclude other units or steps, and a single form does not exclude a plural form. The multiple units or modules as stated in apparatus claims can also be implemented by a single unit or module through software or hardware. Terms such as first and second are used to represent names, not representing any specific sequence.

### LIST OF ABBREVIATIONS IN THE DESCRIPTION AND DRAWINGS

| | |
|---|---|
| 3GPP | 3rd Generation Partnership Project |
| AS | Application Server |
| API | Application Programming Interface |
| GSMA | Global System for Mobile Communications assembly |
| IP-SM-GW | Internet Protocol Short Message GateWay |
| IoT | Internet of Things |
| M2M | Machine-to-Machine communications |
| MME | Mobility Management Entity |
| MTC | Machine-Type Communications |
| MTC-IWF | MTC-Inter Working Function |
| OMA | Open Mobile Architecture |
| SGSN | Serving GPRS Support Node |
| SMS | Short Message Service |
| SMS-SC | SMS-Service Center |
| UE | User Equipment |

1. A method for steering operations corresponding to a trigger request in a steering device, wherein the method comprises:
x. obtaining one or more steering policy parameters transmitted by an application server, wherein the steering policy parameter includes one or more network conditions and a predetermined operation corresponding to the network condition;
wherein the method further comprises:
a. detecting whether a current network situation matches the network condition;
b. if the current network situation matches the network condition, executing the predetermined operation corresponding to the network condition to the trigger request transmitted by the application server based on the steering policy parameter.

2. The method according to claim 1, wherein the step x comprises:
obtaining one or more trigger requests transmitted by an application server, wherein the trigger request includes one or more steering policy parameters, and the steering policy parameter includes one or more network conditions and a predetermined operation corresponding to the network condition;
obtaining the steering policy parameters based on the trigger request.

3. The method according to claim 1, wherein the step b comprises:
if the current network situation matches the network condition, based on the steering policy parameter and in conjunction with payload information in the trigger request transmitted by the application server, executing the predetermined operation corresponding to the network condition and the payload information to the trigger request.

4. A method for facilitating steering of operations corresponding to a trigger request in an application server, wherein the method comprises:
X. transmitting one or more trigger requests and steering policy parameters to a steering device, wherein the steering policy parameter includes one or more network conditions and a predetermined operation corresponding to the network condition.

5. The method according to claim 4, wherein the step X comprises:
transmitting one or more trigger requests to a steering device, wherein the trigger request includes one or more steering policy parameters, and the steering policy parameter includes one or more network conditions and a predetermined operation corresponding to the network condition.

6. The method according to claim 4, wherein the method further comprises:
generating one or more steering policy parameters based on application demand information, wherein the steering policy parameter includes one or more network conditions and a predetermined operation corresponding to the network condition;
wherein the step X comprises:
transmitting one or more trigger requests and the steering policy parameters to a steering device.

7. A steering device for steering operations corresponding to a trigger request,
wherein, the device comprises:
a policy obtaining module configured to obtain one or more steering policy parameters transmitted by an application server, wherein the steering policy parameter includes one or more network conditions and a predetermined operation corresponding to the network condition;
wherein the device further comprises:
a detecting module configured to detect whether a current network situation matches the network condition;
an executing module configured to, if the current network situation matches the network condition, execute the predetermined operation corresponding to the network condition to the trigger request transmitted by the application server based on the steering policy parameter.

8. The steering device according to claim 7, wherein the policy obtaining module is configured to:
obtain one or more trigger requests transmitted by an application server, wherein the trigger request includes one or more steering policy parameters, and the steering policy parameter includes one or more network conditions and a predetermined operation corresponding to the network condition;
obtain the steering policy parameters based on the trigger request.

9. The steering device according to claim 7, wherein the executing module is configured to:
if the current network situation matches the network condition, based on the steering policy parameter and in conjunction with payload information in the trigger request transmitted by the application server, execute the predetermined operation corresponding to the network condition and the payload information to the trigger request.

10. An application server for facilitating steering of operations corresponding to a trigger request, wherein the application server comprises:
a policy transmitting module configured to transmit one or more trigger requests and steering policy parameters to a steering device, wherein the steering policy parameter includes one or more network conditions and a predetermined operation corresponding to the network condition.

11. The application server according to claim 10, wherein the policy transmitting module is configured to:
transmit one or more trigger requests to a steering device, wherein the trigger request includes one or more steering policy parameters, and the steering policy parameter includes one or more network conditions and a predetermined operation corresponding to the network condition.

12. The application server according to claim 10, wherein the application server further comprises:
a policy generating module configured to generate one or more steering policy parameters based on application demand information, wherein the steering policy parameter includes one or more network conditions and a predetermined operation corresponding to the network condition;
wherein the policy transmitting module is configured to:
transmit one or more trigger requests and the steering policy parameters to a steering device.

13. (canceled)

14. (canceled)
